(19) United States
(12) Patent Application Publication
(10) Pub. No.: US 2002/0173042 A1
(43) Pub. Date: Nov. 21, 2002

(54) Method of tagging agricultural products

(76) Inventors: Timothy Oolman, Plymouth, MN (US); Dirk L. Reif, Eden Prairie, MN (US); Robert T. Kean, Minneapolis, MN (US)

Correspondence Address: Peter M. Reyes, Jr., Law Department, Cargill, Inc., P.O. Box 5642, Minneapolis, MN, 55440-5624, US

(21) Appl. No.: 10/097,883

(22) Filed: Mar. 14, 2002

Related U.S. Application Data
(60) Provisional application No. 60/276,331, filed on Mar. 16, 2001.

(51) Int. Cl. G01N 37/00

(52) U.S. Cl. 436/56; 436/164; 436/171; 436/173

(57) ABSTRACT

Compounds and methods for tagging bulk agricultural products for identity preservation are provided. The tagging agents are typically dissolved and/or dispersed in a carrier and applied to a bulk agricultural product in an amount sufficient to allow detection from a randomly drawn sample of the bulk agricultural product. The presence or absence of the tagging agent in a sample of a bulk agricultural product can be detected using a wide variety of analytical methods. The tagging agent may be detected directly while still on surfaces of bulk agricultural product or may be detected indirectly by analyzing a sample of vapor in contact with the bulk agricultural product or a solution generated by washing a sample of the bulk agricultural product with a solvent.

### CROSS REFERENCE TO OTHER APPLICATIONS

This application claims priority of U.S. Provisional Application Ser. No. 60/276,331, filed on Mar. 16, 2001, the disclosure of which is herein incorporated by reference.

### BACKGROUND

With an increasing utilization of genetically modified agricultural products, and a growing demand for organic based agricultural products, there is a growing need for tracking bulk agricultural products from the producer, through worldwide transportation and distribution channels, and into processing facilities. Such tracking mechanisms are commonly referred to as “identity preservation” and are of increasing importance in tracking specific lots of bulk agricultural products having a particular quality, characteristic, specialty trait, or other parameter. Although particular attention is currently being given to the identity preservation of seeds of various cereal grasses, a current need for identity preservation exists with the seeds and fruits of various food plants and is likely to evolve for many other agricultural products.

Current tagging methods include marking explosives, petroleum products, or chemical compounds using a variety of methods based on radioactive materials, perfluorocarbon tracers, luminescent metal chelate labels, or polymeric microparticles. These marking methods may not provide a safe or efficient method to mark products that are intended for human and/or animal consumption, such as bulk agriculture products.

Current technologies for tracking bulk agricultural products through the transportation and distribution channels commonly rely heavily on testing of the agricultural products for the unique traits of each lot. To record and repeatedly verify the unique traits of each lot is cumbersome, excessively redundant, time consuming and expensive. Accordingly, there exists a need for reliable identity preservation of agricultural products which would permit such products to be marked and detected in an efficient, reliable and inexpensive fashion. The present identity preservation methods would work to overcome these and other disadvantages by marking bulk agricultural products with tagging agents that may be easily detected and identified, thereby increasing the accuracy and minimizing the costs of identity preservation.

### SUMMARY

The present application relates to an identity preservation system which can be used to identify and/or track a bulk agricultural product. As used herein, the phrase “bulk agricultural product” refers to any agricultural product in a harvested or processed form that remains in a bulk state, i.e. has not been packaged for end user consumption. The present identity preservation system is particularly useful for identifying and/or tracking a solid bulk agricultural product which is made up of a plurality of particles.

The application describes methods which include tagging particles of the bulk agricultural product with an identifiable tagging agent and compositions for use with the methods. The tagging agent is commonly dissolved and/or dispersed in a carrier as part of a tagging composition. As used herein, the terms “dispersed’ and “dispersion” refer to two phase systems that include particles distributed throughout a bulk phase. Examples of dispersions include liquid/liquid compositions (emulsions), solid/liquid compositions and solid/solid compositions. Quite commonly, the carrier is a non-aqueous, oil-based carrier. In some instances, however, the tagging agent may be applied in a form where it is unaccompanied by other material(s), e.g., where the tagging agent is applied as a neat liquid or solid.

It is particularly desirable to employ a tagging agent which is consumption- safe. As used herein, “consumption-safe” means that up to specified amounts of the particular agent (either a single chemical compound or a mixture of compounds) can be ingested by a human and/or animal (e.g., in animal feed) without generally causing deleterious health effects. In the case of human consumption, it is particularly desirable that the tagging agent is food safe. As used herein, “food safe” is intended to mean that up to specified amounts of the particular agent (either a single chemical compound or mixture of compounds) can be ingested by a human without generally causing deleterious health effects. Examples of food-safe agents include those agents “generally recognized as safe” (“GRAS”) by the United States Food and Drug Administration.

In one embodiment, a bulk agricultural product may be marked by a method which includes introducing an oil-based composition onto surfaces of particles of the bulk agricultural product. It may be particularly desirable to utilize an oil-based composition containing an oil (e.g., mineral oil) and a consumption- safe tagging agent and, in particular, such a tagging agent which is detectable by absorbance spectroscopy and/or emission spectroscopy. For example, the marked bulk agricultural product may include a plurality of grain particles having no more than about 100 ppm of an oil-based tagging composition distributed on surfaces of the grain particles. Unless otherwise stated, all amounts of tagging agent and/or tagging composition in a bulk agricultural product are stated on an add-on basis, either as a wt. % or in ppm. Thus, as used herein, the term “wt. %” refers to the weight of tagging agent or tagging composition present (applied) as a weight percentage of the total dry weight of the corresponding untreated particles.

The present application also describes methods for detecting a tagging agent which has been introduced onto at least a portion of the particles of a bulk agricultural product. As employed herein, “detecting” a tagging agent means determining the presence or absence of the tagging agent in a sample being examined. The presence of the tagging agent in the sample may be determined either qualitatively or quantitatively. As used herein, a “qualitative determination” refers to detecting the presence (or absence) of at least a certain minimum level of tagging agent in a bulk agricultural product. Alternatively, the amount of tagging agent may be measured quantitatively. In some instances, the amount of tagging agent may be determined in a “semi-quantitative” manner, i.e., the amount of tagging agent may be determined to fall within one of two or more ranges, e.g., high/low or high/medium/low concentration.

A wide variety of analytical methods may be used to detect the presence or absence of the tagging agent. Examples of suitable analytical methods include absorbance spectroscopy, emission spectroscopy, mass spectroscopy, nuclear magnetic resonance spectroscopy, gas chromatography, immunoassay, microscopy, and elemental analysis. Where the analytical method involves absorbance and/or emission spectroscopy, the spectroscopic technique(s) can employ various wavelengths of light, e.g., light with wavelengths from the x-ray through infrared portions of the electromagnetic spectrum. In particular, ultra violet spectroscopy, visible spectroscopy, infrared spectroscopy (particularly near IR at circa 1-10 micron wavelengths and/or mid IR at circa 10-200 micron wavelengths), or combinations thereof can provide a quite suitable basis for a detection method.

The presence or absence of the tagging agent in a particular lot of a bulk agricultural product may be detected directly or indirectly. For example, in some instances, the presence of a tagging agent on or near the surface of the particles of the bulk agricultural product may be detected directly via spectroscopy. The presence (or absence) of the tagging agent may also be detected through analysis on a sample taken from the tagged bulk agricultural product. For example, a sample of the tagged bulk agricultural product in question may be contacted with a wash solution (e.g., an organic solvent such as hexane or ethanol) and the wash solution may be subsequently analyzed to determine the presence or absence of the tagging agent. In another embodiment of the invention, the tagged bulk agricultural product may be marked with a volatile tagging agent. The presence or absence of the volatile tagging agent in a bulk agricultural product may be determined by analyzing a sample of vapor in contact with the bulk agricultural product.

In some embodiments, the tagging agents and corresponding detection methods may be chosen such that imaging technology can be used to discretely quantify the fraction of particles in a given sample which have been tagged. This may suitably be carried out by imaging an appropriately tagged bulk product using absorption and/or emission spectroscopy. For example, using conventional imaging spectroscopy, the discrete particles of grain or oilseed could be detected as having or lacking a particular fluorescent tag. With adequate sample sizes, such imaging techniques may provide a more precise quantification of tagged versus untagged particles than other analytical methods.

The tagged bulk agricultural products employed in the present methods commonly include particles tagged with no more than about 1000 ppm (0.1 wt. %) of the tagging composition. In some instances, e.g., where the bulk agricultural product is a lot of cereal grain or oil seeds, it may be desirable to apply no more than 200 ppm (0.02 wt. %) of the tagging composition.

### DETAILED DESCRIPTION

A suitable method to preserve the identity of a bulk agricultural product includes selecting an identifiable tagging agent, then applying the tagging agent to sufficient particles of the bulk agricultural product so as to enable detection of the tagging agent from a randomly drawn sample. An important value of the present identity preservation method involves the potential to utilize a tagging agent(s) that can be detected without the expensive analytical procedures often required to measure the specific traits of a particular crop. Although analysis of specific crop traits may still be required by regulation or customer demands, the present identity preservation methods could provide a less expensive and potentially more reliable alternative as a secondary or primary testing method. The present method, by facilitating the tracking of lots of material through a distribution system may decrease the number of analyses of a specific crop trait that need to be conducted on a given lot of material.

The present identity preservation methods typically includes detecting the tagging agent(s). Detection typically includes acquiring a sufficient sample of the bulk agricultural product, a sufficient sample of the environment in which the bulk agricultural product is or was kept, and/or a sufficient sample of a material derived from the bulk agricultural product. The sample can be analyzed using chemical, spectroscopic, elemental analysis and/or physical means to establish the presence or absence of the tagging agent. The determination of the presence of the tagging agent may be conducted in a qualitative, quantitative or semi-quantitative manner.

Bulk Agricultural Product

The present identity preservation methods may be utilized to tag specific lots of bulk agricultural product, which may include any seed or fruit from a variety of plants used for feed and/or food. The present identity preservation methods are particularly suitable for tagging seeds and related material from cereal grains. Grains and oilseeds, such as corn, soybeans, wheat, oats, barley, rice, rapeseed, and sorghum, are particularly suitable for the present identity preservation methods. The methods described herein, however, may be applied to other fruits, vegetables and agricultural products.

Bulk agricultural product may further include processed forms of any seed or fruit from a variety of plants used for feed and/or food. For example, in the case of the cereal growing, bulk agricultural product may refer to the cereal growing essentially as harvested, as a pressed or crushed grain, as meal, flour, or a syrup. Bulk agricultural product will typically include an agricultural product in any number of processed forms that has not yet been packaged for end user consumption.

It is important to note that although many of the examples and descriptions herein are applied to bulk seed, especially seeds from the cereal grains, the present identity preservation methods should not be construed to be so limited, and may be applied to other bulk agricultural products, particularly those which include a plurality of particles.

Tagging Agent

A suitable tagging agent includes any identifiable material which can be applied to the particles of a bulk agricultural product then subsequently detected by performing a chemical, spectroscopic, physical or other analysis on the tagged agricultural product, the bulk agricultural product's environment, or material derived from the bulk agricultural product, individual particles of the bulk agricultural product, or representative samples thereof. Tagging agents that include detectable quantities of a material that is not naturally present on the surfaces of the particles of the bulk agricultural product are particularly suitable. The tagging agent may, however, be a compound or composition that is naturally present as part of the agricultural product. In such instances, the tagging agent is generally not applied in significantly higher amounts than normally present.

The tagging agent(s) is desirably differentiable, if not unique, to a particular lot of bulk agricultural product. A nearly infinite number of tagging agents may be developed, such as by varying the chemistry of the tagging agent, varying the amount of tagging agent, combining two or more individual tagging agents to create a composite tagging agent, and/or varying the relative amounts of individual tagging agents in a composite tagging agent. Moreover, any individual or composite tagging agent may be reused for lots of product with identical traits, or reused once the previously identically tagged lot has moved through a processing or distribution stream, or is far enough through the processing or distribution stream to enable differentiation between separate lots.

A suitable tagging agent may impart a visibly detectable trait to the bulk agricultural product. In consideration of consumer appeal, a tagging agent may impart an identifiable color to the bulk agricultural product. Typically, however, the tagging agent will not impart a color which is identifiable to the eye of an observer.

In the event that an agricultural product is intended for human and/or animal consumption, choosing a consumption-safe tagging agent is advantageous, if not required by government regulation. Accordingly, whether designed for human, animal or other use, the tagging agents should preferably be chosen to encounter minimal regulatory barriers for a specific implementation.

Suitably, the present identity preservation methods would tag specific lots of bulk agricultural product with inexpensive and easy to identify tagging agents. Examples of suitable tagging agents include color additives or other materials that have been approved or may be authorized for food use by the United Sates Food and Drug Administration (FDA). Suitable food-safe tagging agents may include carotenoids, flavonoid pigments (e.g., riboflavin and anthocyanins,), porphyrins, phenolic compounds, and phycobillins. Suitable peptides include peptides which include substantial amounts (e.g., at least about 20% of the peptide residues) of tyrosine and/or tryptophan residues. Other suitable food-safe tagging agents include carotenoids such as bixin, capsanthin, beta-carotene, lycopene, crosin, and retinol. Further examples of suitable food-safe tagging agents include phenolic compounds such as curcumin, vanillin, propyl gallate, methyl paraben, propyl paraben, tocopherol, tocopherol acetate, and tocopherol palmitate. Other examples of suitable feed-safe tagging agents include anthocyanins, such as cyanin, cyanidin and delphinidin. Tagging agents which are derived from natural sources can include complex mixtures of compounds from one or more of the categories mentioned above. Examples of complex naturally derived color additives include extracts, oleoresins and oils derived from plant or insect sources. A number of examples of complex naturally derived color additives are listed in Table I below.

Other examples of suitable food-safe tagging agents include color additives on the FDA's list of color additives which are categorized as being “generally recognized as safe” (“GRAS”) for use as color additives in food products. Examples of such additives include FD&C Blue #1, FD&C Blue #2, FD&C Greene #3, FD&C Red #3, FD&C Red #40, FD&C Yellow #5, and FD&C Yellow #6. Further examples of suitable tagging agents can be found in Table I.

TABLE I
Food-Safe Tagging Agents

| | |
|---|---|
| Annatto | Grape Color Extract |
| Betanin | Paprika oleoresin |
| Beet extract | Saffron |
| Caramel | Tumeric oleoresin |
| Carminic acid | Thiamine hydrochloride |
| Corn Endosperm Oil | Vitamin B12 (Cyanocobalamin) |
| Carrot Oil | Fruit Juice |
| Cochineal extract | Vegetable Juice |
| Carmine (alum lake of Natural Red #4) | |

In another embodiment of the invention, the tagged bulk agricultural product may be marked with a volatile tagging agent. As referred to herein, a “volatile tagging agent” is a chemical compound or mixture of compounds which can be detected by analysis of a sample of vapor in contact with the bulk agricultural product. For example, if the tagged bulk agricultural product is stored in a container, the vapor in the headspace of the container may be analyzed to detect the presence or absence of the volatile tagging agent. The volatile tagging agent may also be present in vapor in the interstitial spaces between particles in a bulk agricultural product (even where stored in an open container).

Examples of compounds that could be employed as volatile tagging agents include hexanes and related higher molecular weight volatile hydrocarbons (e.g., C₇-C₂₀ alkanes, alkenes and/or aromatics), ethanol and related higher molecular weight volatile alcohols (e.g., C₃-C₂₀ alcohols), carbon dioxide (introduced as a solid and/or a gas) and fluorinated hydrocarbons (e.g. perfluorinated C₈-C₃₀ alkanes and perfluorokerosines). Other examples of compounds that could be employed as volatile tagging agents include esters (e.g., C₃-C₂₅ esters, such as alkyl esters of fatty acids) and carboxylic acids (e.g., C₂-C₂₀ fatty acids). In the event a particular volatile tagging agent is not consumption-safe, the tagging agent may be removed prior to or during processing or packaging. Application

The tagging agent may be dissolved and/or dispersed in an aqueous or non- aqueous carrier before applying the tagging agent to the bulk agricultural product. Examples of suitable carriers include oils, water, waxes, glycerol and other organic solvents. Typically, a tagging agent is mixed with a carrier to form a composition which includes the tagging agent in a final concentration of 0.1 to 50 wt. % and, more suitably 1 to 10 wt. %.

Suitable application of a tagging agent may involve dissolving and/or dispersing the tagging agent in a carrier and then applying the resulting tagging composition to the bulk agriculture product. The tagged composition is typically applied to surfaces of individual particles of the bulk agricultural product. Depending on the nature of the agricultural product and the application method, the tagging agent may be absorbed, at least in part, into the product. Typically, a tagging composition is applied to at least a portion of the particles of the bulk agricultural product. Very often where the tagging composition is only applied to a portion of the bulk agricultural product, the normal processing operation(s) that the agricultural product is subjected to will result in the tagged particles becoming distributed throughout the bulk agricultural product.

Although application of the tagging agent to each individual particle may not be necessary, or practicable, for most agricultural products, it is desirable to apply the tagging agent to enough particles in the bulk agricultural product to enable detection from a randomly drawn sample. The less uniformly the tagging agent is applied, the larger the sample will be necessary to achieve a desired level of statistical precision. In many instances, however, there is generally a practical limit on the size of sample that can be routinely collected. The size of the sample will vary depending on the agricultural product. For example, in the case of cereal grains, a suitable sample may include 10 g to 10 Kg. In the case of fruit, a suitable sample may include 1 to 100 pieces.

The tagging agent may be applied to the bulk agricultural product in the context of an existing processing steps (i.e., a dust control, washing or waxing step) or an added step at or near the point of origination or subsequent transfer points. This can often conveniently be done by applying the tagging composition to the bulk agricultural product at a critical transfer point in a distribution chain, e.g., using equipment which sprays oil onto grain for dust control during truck offloading into storage elevators. For example, cereal grains are often spayed with a low level (typically no more than about 100 ppm) of mineral oil to suppress dust production. This permits a tagging agent to be introduced as a solution and/or dispersion in mineral oil at an early stage of the commercial distribution process. Oil soluble tagging agents which have been certified by an appropriate regulatory agency as being consumption-safe are particularly desirable tagging agents for use in marking lots of cereal grains intended for human consumption. Examples of suitable food- safe, oil soluble tagging agents include oleoresins of tumeric or paprika.

The tagging agent is suitably applied to the bulk agricultural product in the context of an existing transfer point or processing step. For example, the existing practice of spraying oil on grains to control dust provides a suitable application method for the tagging agents. Since these dust control measures are broadly implemented at grain elevators and barge loading facilities, there is an existing infrastructure that would allow application of the tagging agent near the point of origination. A suitable tagging agent may be dissolved, suspended, dispersed or emulsified in the oil, typically mineral oil, and applied during routine dust control procedures.

Another example is the application of materials such as wax to fruits and vegetables. A suitable tagging agent may be dissolved, suspended, dispersed or emulsified in the wax and applied during routine processes. In other instances, the tagging agents may be applied together with a volatile solvent. Depending on the subsequent processing of the bulk agricultural product and the volatility of the solvent among other factors, the solvent may not be permanently retained by the bulk agricultural product.

Once combined with a carrier to form a tagging composition, the tagging agent is typically applied to a lot of agricultural product in a manner and amount sufficient to enable detection of the tagging agent from a randomly drawn sample. In other embodiments, the tagging agent may be applied to the agricultural product in an manner that would permeate the entire lot. Typically, the tagging composition is applied to the bulk agricultural product at not more than 1000 ppm and often at not more than 500 ppm. For many agricultural products, application of no more than 200 ppm and, more desirably, no more than 100 ppm of the tagging composition is sufficient. Some agricultural products, however, may require an application of no more than 50 ppm of the tagging composition. The specific amount of tagging composition applied to a particular agricultural product will vary and will depend on a number of factors including the detection method to be employed, limitations due to consumer taste or visual appeal preferences, the nature of the agricultural product, storage and handling conditions that the tagged product is likely to experience, and the length of time the tagging agent should remain detectable.

Detection

The present identity preservation methods allow identification of the tagging agent by simple analytical methods that can be applied at multiple points along transportation and distribution channels.

The tagging agents are typically detectable through simple analytical methods that may be applied at any number of points throughout the transportation and distribution channels. Typically, the analytical method will involve analyzing the bulk agricultural product, analyzing a sample taken from the bulk agricultural product, analyzing the present or past environment of the bulk agricultural product, analyzing the present or past packaging of the bulk agricultural product, analyzing a material derived form the bulk agricultural product or analyzing a sample taken therefrom. Depending on the tagging agent, a detection method may be structured to allow immediate analysis of the sample. However, greater sensitivity and lower background interference may be achieved by collecting representative samples of the agricultural products and analyzing off-line.

Depending on the tagged bulk agricultural product and the tagging agent, suitable detection may include analytical methods such as absorbance spectroscopy, emission spectroscopy, mass spectroscopy, nuclear magnetic resonance spectroscopy, flame ion spectroscopy, ionic absorption/emission spectroscopy, elemental analysis, gas chromatography, electron spin resonance spectroscopy, vibrational spectroscopy, immunoassay and microscopy. As noted elsewhere if a spectroscopic method(s) is employed, the method may involve ultra violet spectroscopy, visible spectroscopy and/or infrared spectroscopy. In many instances, the accuracy of the determination may be enhanced by employing more than one detection method, e.g., by employing gas chromatography in combination with mass spectroscopy (commonly referred to as “GC/mass spec” or GCMS”).

Several potential examples of specific tags and detection mechanisms include: UV, Visible or NIR absorbing dyes can be detected at very low levels by relatively simple spectroscopic methods. Standard color additives such as food dyes/colorants, natural coloring agents (carotenoids, xanthophylls, porphyrins, etc.), other naturally occurring UV/vis absorbing compounds (e.g., phenolic acids, flavins, quinones, phycobillins, tyrosine and/or tryptophan containing peptides), and fluorescent dyes can often be suitably detected using absorbance spectroscopy (i.e., ultraviolet, visible, or infrared spectroscopy), fluorescence spectroscopy, and/or phosphorescence spectroscopy. These detection methods may be used for bulk analysis or in an imaging mode to detect tagging agents on individual pieces of grain. In another embodiment, these spectroscopic detection methods can be utilized to detect the presence of a tagging agent in a wash solution formed by contacting the tagged bulk agricultural product with a solvent. If desired, the wash solution can be concentrated using a variety of methods known to those of skill in the art to enhance the sensitivity of the identification process.

Low volatility hydrocarbons of varying chain length, branching or other structural features, such as mineral oils, fatty acid esters, waxes, may be detected using GC and/or MS after laser/thermal desorption from the product surface.

In some instances, a volatile tagging agent can be detected by placing a sample of a tagged bulk agricultural product in a closed container and removing the vapor phase from the container with the aid of a vacuum. The vapor removed from an evacuated container may often be recovered in a trap (e.g., a trap cooled to a temperature of about −195° C. via cooling with liquid nitrogen) and subsequently analyzed. When a vacuum or partial vacuum is utilized to as part of the sampling procedure, the tagging agent may not have a significant vapor phase concentration under ambient conditions (e.g., at one atmosphere) but can have a significant vapor phase concentration under reduced pressure conditions (e.g., conditions resulting from evacuating the headspace of a closed container to about 15-20 mm-Hg (circa 0.02 atmosphere)). In other words, there may not be a measurable concentration of the “volatile tagging agent” in the vapor phase without the application of at least a partial vacuum to a sample of the bulk agricultural product. So long as tagging agents can be detected from vapors in contact with a sample of the bulk agricultural product such agents, are encompassed within the definition of “volatile tagging agent” as the term is used herein.

Organic compounds with unique band patterns, such as aromatic compounds, nitrate containing compounds, carbonate containing compounds, may suitably be detected using various vibrational surface analysis spectroscopy techniques (e.g., Transient IR emission spectroscopy (“TIRES”), or photoacoustic detection (“ATR”), or Raman spectroscopy).

Consumption-safe compounds may also be labeled with altered stable isotope ratios. For example, oils/waxes with enhanced amounts of deuterium or carbon-13 may suitably be detected using NMR and/or MS. In some instances, vibrational spectroscopic techniques, such as IR or Raman spectroscopy, may also be applicable to the detection of altered isotope ratios.

Other methods known to those skilled in the art may also be employed to mark bulk agricultural products. Additional examples of potential tagging agents include stable radical species, such as nitroxide labeled compounds, which can suitably be detected using electron spin resonance spectroscopy (“ESR”). Atomic species, ions, chelates, or minerals, such as Mg, Ca, K, S, Si, Ba, Ti may suitably be detected using x-ray fluorescence. Small particles of minerals, pigments, crystals, such as NaCl, carbon, Talc, Silicates may be detected using microscopy. Antibodies may be used to detect the presence of particular antigens, such as species specific proteins and carbohydrates, using immunoassays.

Illustrative Embodiments

A description of a number of illustrative embodiments is provided below. The embodiments described are intended to illustrate the present compositions and methods and are not intended to limit their scope.

A method for marking a bulk agricultural product including a plurality of agricultural particles is provided. The method includes applying a tagging composition to agricultural particles, wherein the tagging composition comprises an oil-based carrier and a consumption-safe tagging agent. The tagging composition may include more than one consumption-safe tagging agent. Applying the tagging composition typically includes applying no more than about 1000 ppm of the tagging composition to the agricultural particles. Commonly, the bulk agricultural product includes a plurality of seed particles and applying the tagging composition includes spraying no more than about 200 ppm of the tagging composition onto the seed particles. Usually, the tagging composition is applied onto surfaces of the agricultural particles.

A variety of techniques can be used to detect the presence of tagging agent in a particular lot of bulk agricultural product. For example, the tagging agent may be detectable by absorbance spectroscopy, emission spectroscopy or a combination thereof. Examples of suitable absorbance and/or emission techniques include ultra violet spectroscopy, visible spectroscopy, and vibrational spectroscopy. Other methods which may be used to detect the presence of tagging agent include mass spectroscopy, nuclear magnetic resonance spectroscopy, electron spin resonance spectroscopy, gas chromatography, immunoassay, microscopy, flame ion spectroscopy, element analysis. Very often it is advantageous to employ a consumption-safe tagging agent which is food-safe.

A bulk agricultural product may be marked by a method which includes introducing a tagging composition onto surfaces -of particles of said bulk agricultural product, wherein the tagging composition comprises an oil and a consumption-safe tagging agent detectable by absorbance spectroscopy, emission spectroscopy or a combination thereof. It may be advantageous to employ a tagging composition which includes mineral oil in such a method. The method can be utilized with a bulk agricultural product derived from corn, soybean, wheat, oats, barley, rice, rapeseed, sorghum or a mixture thereof. Very often, the bulk agricultural product includes a plurality of seeds. Preferably, the consumption-safe tagging agent is a food-safe tagging agent.

A bulk agricultural product can be identified by a method which includes: applying a tagging composition to particles of said bulk agricultural product to form a tagged agricultural product, wherein the tagging composition comprises a consumption-safe tagging agent; and detecting the tagging agent in a sample of the tagged bulk agricultural product. Typically, the tagging composition also includes a carrier. The tagging agent may be detected by absorbance spectroscopy, emission spectroscopy or a combination thereof. In some instances the method may include detecting the tagging agent by contacting a sample of the tagged bulk agricultural product with a solvent to form a wash solution; and detecting the tagging agent in a sample of the wash solution. In other instances, the method may include using a detection technique, such as absorbance and/or emission spectroscopy, in an imaging mode to identify the presence of the tagging agent on individual particles of the bulk agricultural product.

A bulk agricultural product can be identified by a method which includes: providing a sample of a tagged bulk agricultural product; wherein the tagged bulk agricultural product includes a plurality of particles having a tagging composition comprising a volatile, consumption-safe tagging agent applied thereto; removing a sample of vapor in contact with the tagged bulk agricultural product; and detecting the tagging agent in the vapor sample. For example, a sample of a tagged bulk agricultural product may be placed in a closed container (or stored under closed conditions); wherein the tagged bulk agricultural product includes a plurality of particles having a tagging composition comprising a volatile, consumption-safe tagging agent applied thereto. The tagged bulk agricultural product can be identified by removing a vapor sample from the container; and detecting the tagging agent in the vapor sample. The tagging agent may be detected in the vapor sample by a method which includes using gas chromatography, mass spectroscopy or a combination thereof.

A bulk agricultural product can be identified by a method which includes: providing a sample of a tagged bulk agricultural product which includes a plurality of grain particles having a tagging composition on surfaces thereof, wherein the tagging composition includes an oil and a consumption-safe tagging agent; and detecting the tagging agent in the sample.

The tagged bulk agricultural product described herein may include a plurality of particles including no more than about 1000 ppm of a tagging composition; wherein the tagging composition includes a carrier and a consumption- safe tagging agent. Typically, the carrier is an oil such as mineral oil. For example, the tagging composition may include the consumption-safe tagging agent dissolved in an oil. Alternatively, the tagged bulk agricultural product may include wherein a tagging composition which includes a consumption-safe tagging agent dispersed in an oil. The tagged bulk agricultural product can include a plurality of seeds having the tagging composition distributed thereon.

The tagged bulk solid material can include a consumption-safe tagging agent which includes at least one compound selected from the group consisting of carotenoids, anthocyanins, flavonoid pigments, porphyrins, phenolic compounds, and phycobillins. Examples of suitable consumption-safe tagging agents may include at least one carotenoid selected from the group consisting of bixin, capsanthin, beta-carotene, lycopene, crosin, and retinol. Examples of suitable consumption-safe tagging agents may include at least one phenolic compound selected from the group consisting of curcumin, vanillin, propyl gallate, methyl paraben, propyl paraben, tocopherol, tocopherol acetate, and tocopherol palmitate. Other examples of suitable consumption-safe tagging agents include anthocyanins, such as cyanin, cyanidin and delphinidin. Examples of suitable consumption-safe tagging agents may include annatto, beet extract, caramel, carrot oil, cochineal extract, corn endosperm oil, grape color extract, paprika oleoresin, saffron, tumeric oleoresin, or a mixture thereof. Examples of suitable consumption-safe tagging agents may include FD&C Blue #1, FD&C Blue #2, FD&C Green #3, FD&C Red #3, FD&C Red #40, FD&C Yellow #5, FD&C Yellow #6, or a mixture thereof. Examples of suitable consumption-safe tagging agents may include a peptide which includes tyrosine residues, tryptophan residues or a combination thereof.

A tagged bulk agricultural product may include a plurality of seeds including no more about 200 ppm of a tagging composition distributed on surfaces of the seeds; wherein the tagging composition comprises mineral oil and a consumption-safe tagging agent.

The invention as described in the following example is illustrative and does not limit the scope of the invention that has been set for the herein. Variation within the concepts of the invention will be apparent.

### EXAMPLE 1

A specific lot of bulk corn (“lot X”) can be marked through the use of the present identity preservation method.

A tagging composition may be prepared by dissolving 1.0 g annatto and 1.0 g paprika oleoresin (collectively the “tagging agent”) in 98 g mineral oil to create a solution including 2.0 wt. % of the tagging agent. This oil-based composition can be sprayed onto the dried kernels of the bulk corn as the kernels passed along a conveyor belt in an amount sufficient provide about 100 ppm of the oil-based composition on the bulk corn (i.e., a tagging agent concentration of about 2.0 ppm). By applying the tagging composition in this manner, no additional step is typically introduced into the process of transferring the bulk corn product, since it is common to spray bulk agricultural products with about 100 ppm mineral oil to reduce the amount of duct generated during handling.

The bulk corn may then shipped to a storage facility. After storage for 60 days, five 20 g samples are randomly taken from the stored bulk corn. Each sample is then slurried with 50 nL hexanes. After standing for five minutes at ambient temperature, the hexane fraction is decanted from the slurry and filtered through a 0.2 micron filter to remove particulate matter. The absorbance of the filtered hexane wash solution is measured at 475 nm and 510 nm (after dilution with hexanes if appropriate). The concentration and ratio of the components of the tagging agent can be determined by comparing the results with the absorbances (at 475 nm and 510 nm) of standard solutions of annatto, paprika oleoresin and mineral oil in hexanes.

The results can be used qualitatively to verify the presence of the originally tagged lot (lot X) in the stored bulk corn. If desired, the results can also be used quantitatively to determine if lot X has been mixed with another lot of bulk corn, e.g., by determining if the concentration of tagging agent is the same or substantially less than the 2.0 ppm concentration of tagging agent originally applied to lot X.

### EXAMPLE 2

Soy beans or kernel corn are commonly transferred from an elevator to barges at a river facility. Existing oil spray equipment is used for dust control to add circa 200 ppm of oil to the grain as it is transported by conveyor belt from a silo to a barge. The oil is spiked with 1000 ppm of bixin (an oil soluble pigment from Annato color) which has a pale orange “cheese” color and an absorbance maxima at about 433 nm and/or with beta-carotene which has an absorbance maxima at about 452 nm.

When barges are off-loaded into cargo ships, e.g., on the Gulf Coast of the United States, 100 g samples (approximately 100-200 soybeans or corn kernels) can be collected from the cargo hold in the barge, storage silos, cargo holds in the ocean vessel, and/or off conveyor belts between these locations. The 100 g samples can be washed with 50 ml of hexane to extract the oil and tagging agent(s) from the surface of the particles. Tumbling of the samples with hexane may be necessary to get sufficient contact and extraction. After separation from the particles, the hexane extracts can be analyzed by measuring their absorbance at 433 nm and/or 452 nm.

In some instances, it may be necessary to dilute or concentrate the hexane extract to facilitate a quantitative measurement of the amount of recovered tagging agent(s).

The invention has been described with reference to various specific and illustrative embodiments and techniques. However, one skilled in the art will recognize that that many variations and modifications may be made while remaining within the spirit and scope of the invention.

What is claimed is:

1. A method for marking a bulk agricultural product including a plurality of agricultural particles, the method comprising:
introducing a tagging composition onto surfaces of the agricultural particles, wherein the tagging composition comprises a carrier and a food-safe tagging agent.

2. The method of claim 1 wherein the tagging composition comprises a second food-safe tagging agent.

3. The method of claim 1 wherein said bulk agricultural product comprises a plurality of seed particles; and introducing the tagging composition comprises spraying the tagging composition onto the seed particles.

4. The method of claim 1 comprising introducing no more than about 200 ppm of the tagging composition onto the surfaces of said bulk solid material.

5. The method of claim 1 wherein the tagging agent is detectable by absorbance spectroscopy, emission spectroscopy or a combination thereof.

6. The method of claim 1 wherein the tagging agent is detectable by mass spectroscopy.

7. The method of claim 1 wherein the tagging agent is detectable by at least one of ultra violet spectroscopy, visible spectroscopy, and infrared spectroscopy.

8. The method of claim 1 wherein the carrier comprises mineral oil.

9. The method of claim 1 wherein the agricultural product is derived from corn, soybean, wheat, oats, barley, rice, rapeseed, or sorghum.

10. The method of claim 1 wherein said bulk solid material comprises a plurality of seeds.

11. A method of tracing a bulk agricultural product, the method comprising:
introducing a tagging composition onto surfaces of particles of a bulk agricultural product to form a tagged agricultural product, wherein the tagging composition comprises a carrier and a tagging agent; and
detecting the tagging agent in a sample of the tagged bulk agricultural product.

12. The method of claim 11 wherein detecting the tagging agent comprises detecting the tagging agent in the sample using absorbance spectroscopy, emission spectroscopy or a combination thereof.

13. The method of claim 11 wherein detecting the tagging agent comprises contacting the tagged bulk agricultural product with a solvent to form a wash solution; and detecting the tagging agent in the wash solution.

14. A tagged bulk agricultural product comprising:
a plurality of particles including no more than about 1000 ppm of a tagging composition on surfaces of the particles;
wherein the tagging composition comprises a carrier and a food-safe tagging agent.

15. The tagged bulk agricultural product of claim 14 wherein the tagging composition comprises the food-safe tagging agent dissolved in an oil.

16. The tagged bulk agricultural product of claim 14 wherein the tagging composition comprises the food-safe tagging agent dispersed in an oil.

17. The tagged bulk agricultural product of claim 14 wherein the carrier includes mineral oil.

18. The tagged bulk agricultural product of claim 14 wherein said tagged bulk agricultural product comprises a plurality of seeds having the tagging composition on surfaces thereof.
